(19) United States
(12) Patent Application Publication
(10) Pub. No.: US 2014/0236647 A1
(43) Pub. Date: Aug. 21, 2014

(54) METHOD OF GENERATING A TRAVEL ITINERARY THROUGH SEARCH AND INTERACTIVE OPTIMIZATION OF PREFERENCES

(71) Applicant: Howard Marc Wettan, Burlingame, CA (US)

(72) Inventor: Howard Marc Wettan, Burlingame, CA (US)

(21) Appl. No.: 14/181,842

(22) Filed: Feb. 17, 2014

Related U.S. Application Data
(60) Provisional application No. 61/765,830, filed on Feb. 18, 2013.

(51) Int. Cl. G06Q 50/14; G06Q 10/02

(52) U.S. Cl. CPC G06Q 50/14; G06Q 10/025
USPC 705/6

(57) ABSTRACT

A method for building group travel itineraries includes providing web site associated with a web server, identifying a primary organizer for building a group travel itinerary through the web site, identifying one or more co-planners for building the group travel itinerary through the web site, collecting trip parameters from the primary organizer through the web site, collecting preferences from the one or more co-planners through the web site, building a plurality of group travel itineraries based on the trip parameters and the preferences using a decision engine associated with the web site, presenting the plurality of group travel itineraries to the primary organizer and the one or more co-planners through the web site, receiving feedback from the primary organizer and the one or more co-planners on the plurality of group travel itineraries through the web site, and determining a group travel itinerary using the feedback using the decision engine.

### PRIORITY STATEMENT

This application claims priority to U.S. Provisional Application No. 61/765,830, filed Feb. 18, 2013, hereby incorporated by reference in its entirety.

### FIELD OF INVENTION

The present invention relates to a method of gathering data regarding the travel preferences of individuals planning a group travel itinerary and, through targeted searches of travel databases and iterative optimization, generating a travel itinerary that optimizes such preferences.

### BACKGROUND OF THE INVENTION

Building a travel itinerary for a group of individuals can be a time-consuming and frustrating process. Although a travel agent may be used or various web sites may be used to assist in the process, problems still remain in managing numerous communications among group members regarding travel preferences and available options. What is needed are improved ways of generating a travel itinerary for multiple individuals seeking an itinerary that best accommodates each individual's preferences.

### SUMMARY OF THE INVENTION

Therefore, it is an object, feature, or advantage of the present invention to improve over the state of the art.

It is a further object, feature, or advantage of the present invention to provide for gathering data regarding the travel preferences of individuals planning a group travel itinerary.

It is a still further object, feature, or advantage of the present invention to provide for targeted searches of travel databases and iterative optimization.

Another object, feature, or advantage of the present invention is to provide generating a group travel itinerary that optimizes preferences of users within the group.

One or more of these and/or other objects, features, or advantages of the present invention will become apparent from the specification and claims that follow. No single embodiment need provide each or every object, feature, or advantage as it is contemplated that different embodiments may have different objects, features, or advantages.

According to another aspect, a method for generating a group travel itinerary for a group is provided. The method includes providing a web site associated with a web server, the web site presenting a user interface. The method further includes identifying through the user interface a primary organizer for building a group travel itinerary using the web site, identifying through the user interface one or more co-planners for building the group travel itinerary through the web site, and collecting trip parameters from the primary organizer through the web site. The method further includes collecting preferences from the one or more co-planners through email, the web site or other electronic interfaces, and building a plurality of group travel itineraries based on the trip parameters and the preferences, the building performed using a decision engine associated with the web site and executing on a computing device. The method further includes presenting the plurality of group travel itineraries to the primary organizer and the one or more co-planners through the web site. The method further includes receiving feedback from the primary organizer and the one or more co-planners on the plurality of group travel itineraries through the web site, and determining a group travel itinerary based on the feedback using the decision engine.

According to another aspect, a method for generating a group travel itinerary for a group is provided. The method includes providing a web site associated with a web server, the web site presenting a user interface, identifying through the user interface a primary organizer for building a group travel itinerary using the web site, identifying through the user interface one or more co-planners for building the group travel itinerary through the web site, collecting trip parameters from the primary organizer through the web site, collecting preferences from the one or more co-planners through email, the web site or other electronic interfaces, and building a plurality of group travel itineraries based on the trip parameters and the preferences, the building performed using a decision engine associated with the web site and executing on a computing device. The method further includes presenting the plurality of group travel itineraries to the primary organizer and the one or more co-planners through the web site receiving feedback from the primary organizer and the one or more co-planners on the plurality of group travel itineraries through the web site, determining a group travel itinerary using the feedback using the decision engine, and inviting one or more invitees to join the group.

According to another aspect, a system for generating a group travel itinerary includes a web-based interface provided by a web server, the web-based interface configured for (a) identifying a primary organizer for building a group travel itinerary through the web site, (b) identifying one or more co-planners for building the group travel itinerary through the web site, (c) collecting trip parameters from the primary organizer through the web site, (d) collecting preferences from the one or more co-planners through the web site. The system may further include a decision engine configured to build group travel itineraries based on the trip parameters and the preferences using a decision engine associated with the web site, and a booking engine for booking a selected one of the group travel itineraries.

### BRIEF DESCRIPTION OF THE DRAWINGS

FIG. 1 is a flowchart of one example of using a web-based server computing platform to provide for group travel.

FIG. 2 provides additional details regarding one example of using a web-based server computing platform to provide for group travel.

FIG. 3 illustrates one example of how required activities may be generated for a group travel itinerary.

FIG. 4 illustrates selecting an itinerary for each destination.

FIG. 5 further illustrates selecting an itinerary for each destination.

FIG. 6 illustrates selecting accommodations.

FIG. 7 further illustrates use of a booking engine.

### DETAILED DESCRIPTION OF THE PREFERRED EMBODIMENT

Methods and systems for planning group travel itineraries are provided. The method provides for identifying a primary organizer for the group and one or more co-planners who may be essential co-planners or non-essential co-planners. In addition, any number of additional invitees may join the group upon a subsequent invitation by the primary organizer, or, if permitted, a co-planner. The system guides the process of planning a trip in order to build an itinerary which meets specified trip parameters through interactions with the primary organizer and the co-planners. The system may be a web-based or cloud-based system which may be implemented using any number of combinations of hardware and software. Software and data may be stored on non-transitory computer readable storage medium which is accessible by the hardware.

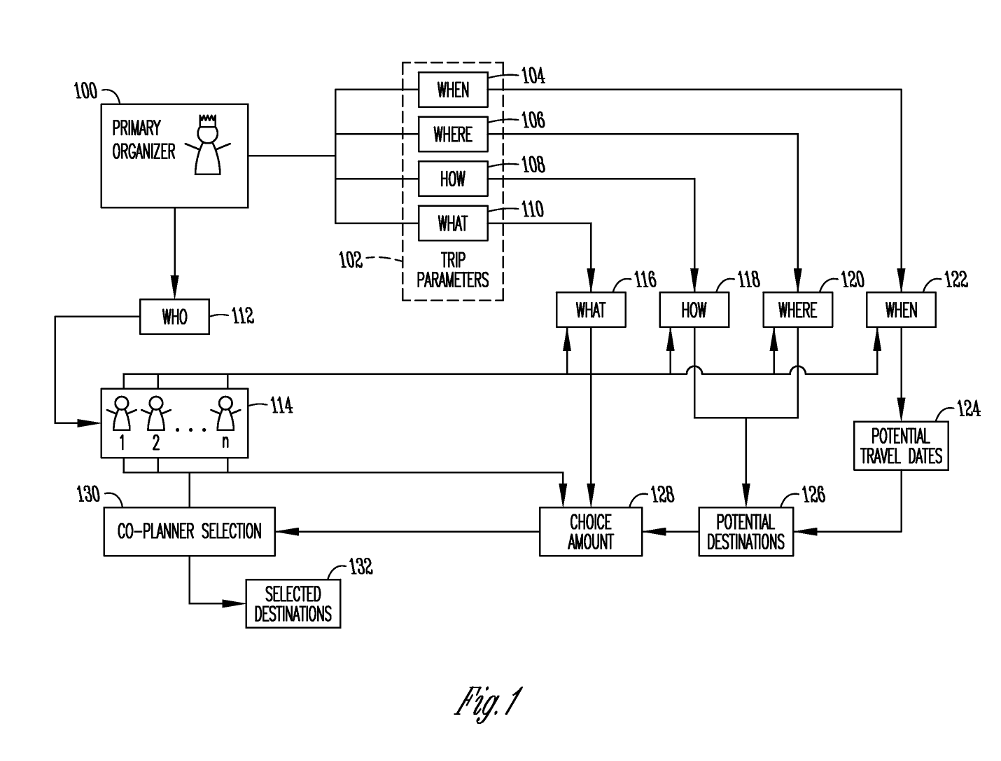

FIG. 1 is a flowchart of one example of method steps for using a web-based server computing platform to gather data about the preferences of prospective participants in group travel expedition and determine a destination, or destinations, for an expedition as well as the dates that such an expedition would occur that optimizes those preferences (the “Decision Platform”). The Decision Platform may be a cloud-based computer server that utilizes a web-based or mobile application client interface to gather information from the person initiating the organization of the trip (“Primary Organizer”) and other trip participants and use the search and computational processes described herein to provide Primary Organizer and each Co-Planner (as defined below) with optimal itinerary choices for a jointly planned trip. Thus, any number of different types of devices may be used to access the system including computers, tablets, phones, and other types of computing devices. The Decision Platform may provide for gathering the information to set the parameters 102 of the expedition using a web interface that presents the Primary Organizer 100 with a series of questions designed to narrow the potential itinerary choices to a limited set of options, for which the number of such options, the “Choice Amount,” can be determined by the Primary Organizer 100.

The Primary Organizer 100 may be prompted to establish basic trip parameters 102 to which the expedition or trip will need to conform. Examples of such trip parameters may include “WHEN” 104. Thus, the Decision Platform may prompt the Primary Organizer to indicate any set of dates during which the Primary Organizer requires that the expedition to occur.

Similarly, the Decision Platform may prompt for the “WHERE” 106 trip parameter, allowing the Primary Organizer to indicate any geographic location to which the Primary Organizer requires the expedition to travel or avoid.

The Decision Platform may prompt for the “HOW” 108 trip parameter, allowing the Primary Organizer to indicate any per-person budget constraints for the cost of the trip, which may or may not include travel to the destination, as well as any requirements for the quality of accommodations or mode of travel.

The Decision Platform may prompt for the “WHAT” 110 trip parameter, allowing the Primary Organizer 100 to indicate what activities the Primary Organizer 100 requires that the expedition include.

Next, the Primary Organizer 100 uses e-mail and social media accounts such as, but not limited to, Facebook, Google and LinkedIn, to invite other individuals (the “WHO” 112) to participate in planning a group trip subject to the constraints established with the trip parameters 102. The Primary Organizer 100 may extend such invitations by individual, or to certain groups, as organized on Facebook, LinkedIn, or on listservs, where up to ‘n’ individuals will then become “Co-Planners” 114 of the expedition and receive a separate set of questions via web, email or other electronic interface prompting each Co-Planner to share their preferences, subject to the original parameters set by the Primary Organizer Although various examples of ways to extend invitations are described, it is contemplated that any number of different web sites, social media platforms, or other communications platforms may be used.

In extending the invitations to the “WHO” 112, the Primary Organizer may also identify which invitees will have privileges to invite others to participate, either as part of the process of planning the expedition or after the destination is selected. In addition, the Primary Organizer may designate individuals as “Essential” for their participation in the trip. By designating certain Co-Planners as Essential (each, an “Essential Co-Planner”), the preference and availability of Essential Co-Planners can be given certain priority.

Each co-planner may also be prompted to input their preferences into the Decision Platform. Thus, each of the co-planners 114 can input their preferences for “WHAT” 116, “HOW” 118, “WHERE” 120, “WHEN 122” or other preferences), into the Decision Platform. Each set of choices provided to Co-Planners shall be constrained and limited to the range of options provided by the Primary Organizer.

For the “WHAT” parameter 116, the Decision Platform prompts each Co-Planner to indicate what activities they deem essential for the expedition, as well as degree of preference for other activities.

For the “HOW” parameter 118, the Decision Platform prompts each Co-Planner to indicate the maximum budget for the expedition for their own household, as well as any minimum requirements for their own household's accommodations or mode of travel, such as the nature or quality of hotels, number of connections for flights, first-class travel, use of other means of transportation, etc.

For the “WHERE” parameter 120, the Decision Platform prompts each Co-Planner to indicate any geographic locations the Co-Planner may have a preference for travelling or not traveling.

For the “WHEN” parameter 122 the Decision Platform prompts each Co-Planner to indicate dates when they are unavailable to participate in the expedition during the set of possible dates selected by the Primary Organizer is Step 1(a).

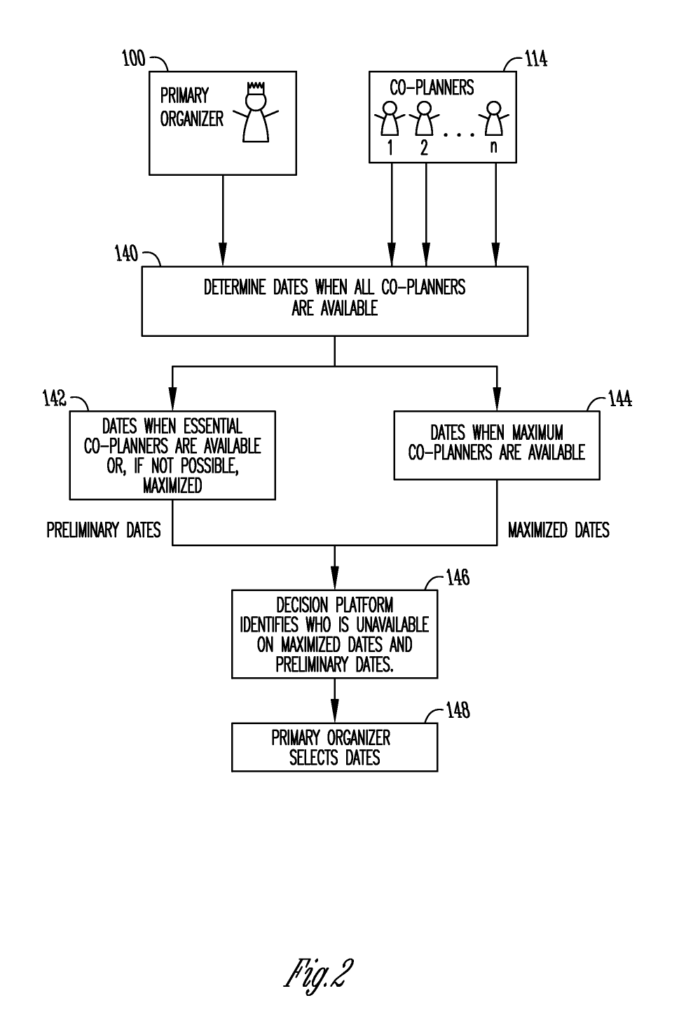

In 124, the Decision Platform compares the set of dates during which the Primary Organizer requires the trip to occur (as specified by the “WHEN” parameter 104) and the dates of availability for travel submitted by Co-Planners (as specified by the “WHEN” parameter 122) to determine potential travel dates 124. This process is further depicted in FIG. 2.

In FIG. 2 a primary organizer 100 and co-planners 114 are shown. In step 140 a Decision Platform selects dates when all Co-Planners are available. If this is not possible, the Decision Platform proceeds to propose to alternative date ranges based on separate methods.

According to a first method, in step 142 a determination is made as to dates when the Primary Organizer 100 and all Co-Planners 114 which are deemed “Essential” are available that also maximize when all other Co-Planners are available. If this is not possible, then according to a second method, in step 144 a determination is made as to dates when the maximum number of Essential Co-Planners are available. Then if there are multiple dates, in step 146 the method may further maximize when all other Co-Planners are available. The dates selected in this manner are “Preliminary Travel Dates.”

In the event the Maximized Dates are not one of the Preliminary Travel Dates, in step 146 of FIG. 2, the Decision Platform will inform the Primary Organizer which Co-Planners will only be available on the Maximized Dates, and which will only be available on the Preliminary Travel Dates.

In step 148 of FIG. 2, after providing this information to the Primary Organizer, the Decision Platform will prompt the Primary Organizer to choose between the Maximized Dates and the Preliminary Travel Dates, the dates chosen being the “Travel Dates.” In the event the Maximized Dates are one of the Preliminary Travel Dates, then such Maximized Dates shall be the “Travel Dates.”

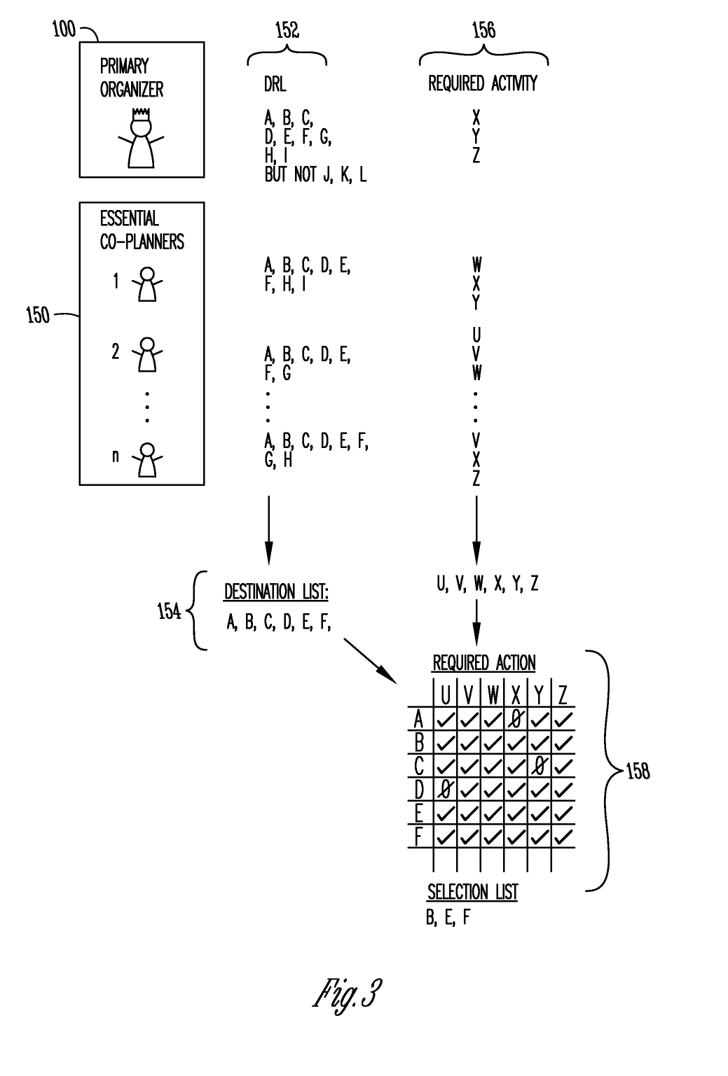

Returning to FIG. 1, in step 126, the Decision Platform determines each Co-Planner who is available to travel on the Travel Dates, (each an “Available Co-Planner”). As illustrated in FIG. 3, for each Available Co-Planner, destinations are identified to which such Available Co-Planner is (a) willing to travel, (b) within the set of destinations required, and not excluded by the Primary Organizer, and (c) within such Available Co-Planner's budget and requirements for accommodations as expressed. For each available Co-Planner such list of feasible destinations during the selected date(s) “DRL” is constructed. Thus there is a set of such lists 152 for the primary organizer 100 and the co-planners 150.

As illustrated in FIG. 3, once a DRL for each Available Co-Planner is assembled, a list 154 is assembled of all destinations (a) that is on the DRL of every Available Co-Planner who is Essential (each, an “Essential Available Co-Planner”), and if such list is a null set, (b) on the maximum number of Essential Available Co-Planners' lists, (the “Destination List” 154).

Returning to FIG. 1, in step 128, a list of destinations is narrowed down to the Choice Amount based on the required and preferred activities of the Primary Organizer, the Essential Available Co-Planners, and all other Available Co-Planners. This process is further illustrated in steps 156, 158 in FIG. 3.

In step 156 of FIG. 3, a list of required activities is assembled based on the responses of Primary Organizer the “WHAT” parameter 110 of FIG. 1 and the Essential Available Co-Planners in “WHAT” parameter of FIG. 1.

In step 158 of FIG. 3, any destination on the Destination List that does not offer all such activities will be removed, the resulting list being the “Selection List.”

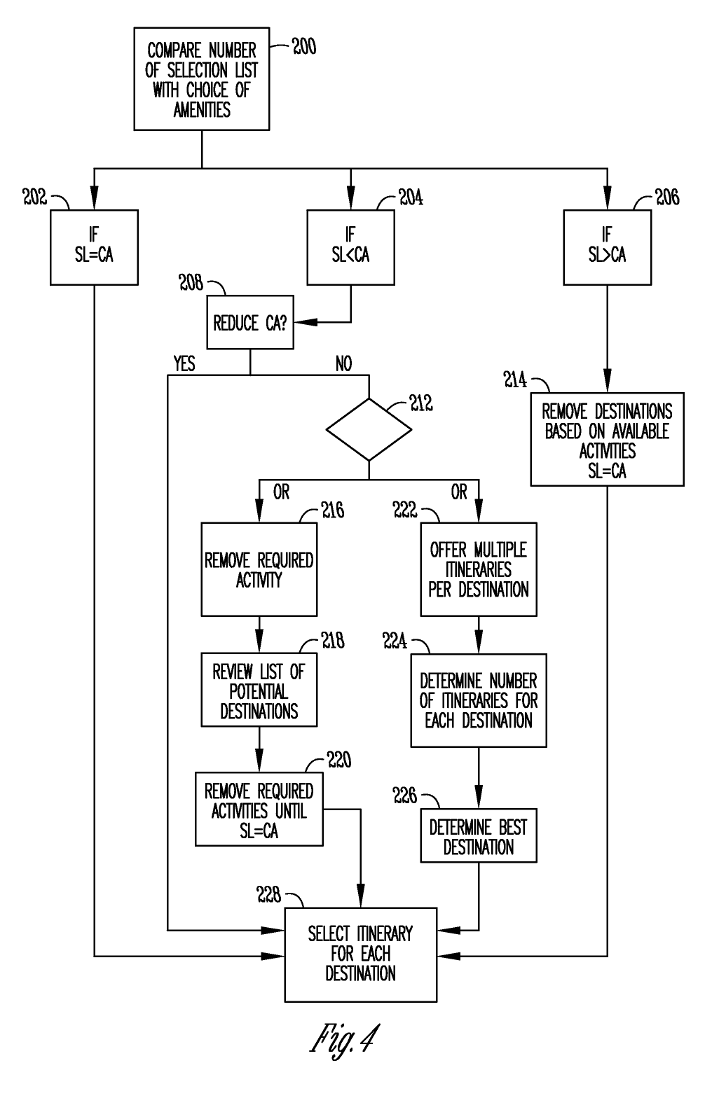

In step 200 of FIG. 4, the Decision Platform will compare the number of destinations on the Selection List to the Choice Amount which is a predetermined maximum number of choices.

In step 202 of FIG. 4, if the list of destinations on the Selection List is equal to the Choice Amount, the Decision Platform will proceed to step 128 of FIG. 1, where it will select a hotel and other travel details for each destination (an “Itinerary”) to be presented on the final list of options to the Co-Planners (the “Choice List”).

In step 204 of FIG. 4, if the list of destinations remaining from step 200 is less than the Choice Amount, the Decision Platform will ask the Primary Organizer whether a list of Itineraries shorter than the Choice Amount should be presented to the Co-Planners. Thus, in step 208, the Primary Organizer is asked to reduce the Choice Amount. If the Primary Organizer says yes, the Decision Platform will proceed to step 228 to select an itinerary for each destination and the process may return to FIG. 1 to create the Choice List.

In step 212 of FIG. 4, if the Primary Organizer says no, the Decision Platform will prompt the Primary Organizer to decide whether to remove a required activity in order to add destinations to the Selection List, or offer multiple Itineraries for some or all of the destinations on the Selection List, as determined in step 224.

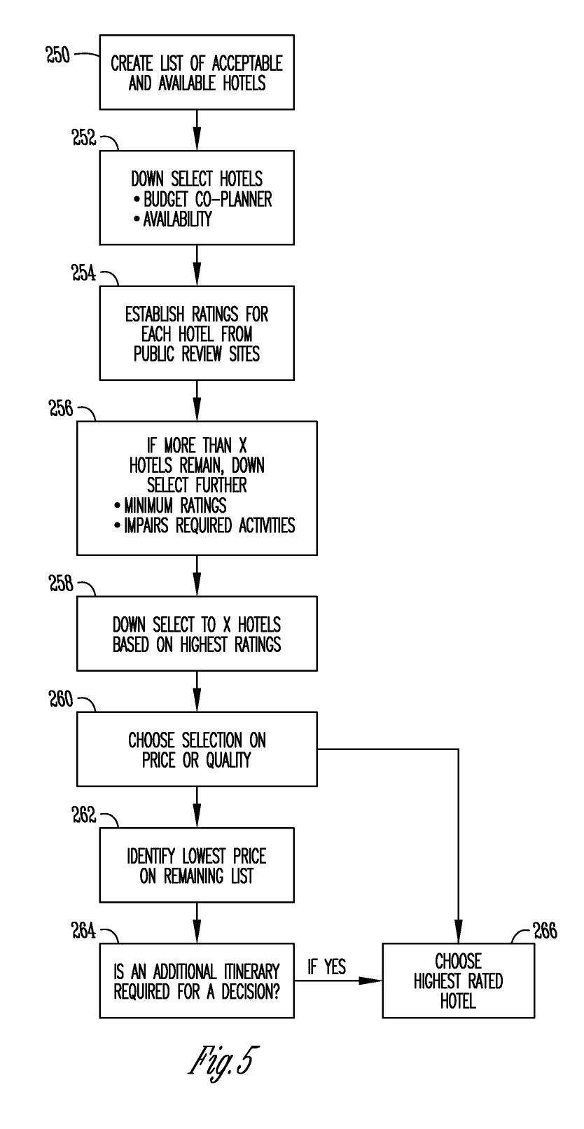

In step 212 of FIG. 4, in the event the Primary Organizer decides to remove a required activity, the Decision Platform will proceed to step 216, in which the Primary Organizer will be presented with a list of destinations that would be added to the Selection List for each required activity that would be removed. The Primary Organizer then removes required activities one at a time until the number of destinations on the Selection List is equal to or exceeds the Choice Amount. If the number of destinations on the Selection List is equal to the Choice Amount, the Decision Platform proceeds to step 126 of FIG. 1, as further illustrated in FIG. 5. If the number of destinations on the Selection List exceeds the Choice Amount, the Decision Platform proceeds to step 206 of FIG. 4.

In step 222 of FIG. 4, in the event the Primary Organizer elects to keep the number of destinations on the Selection List less than the Choice Amount, the Decision Platform will determine how many destinations on the Selection List should offer multiple Itineraries by proceeding to step 224 of FIG. 4.

In step 224, certain, or all, destinations on the Selection List will be subject to multiple itineraries with different hotels, based on which destinations offer the most activities preferred by Available Co-Planners. In step 226, a determination is made as to the best destination.

In step 206 of FIG. 4, in the event the list of destinations on the Selection List is greater than the Choice Amount, the Decision Platform will remove the destination that offers the fewest activities preferred by Available Co-Planners in step 214. The Decision Platform will repeat this process until the number of destinations on the Selection List is equal to the Choice Amount, at which point the Decision Platform can proceed to step 228 choosing Itineraries for each destination, as further illustrated in FIG. 5.

In step 250 of FIG. 5, for each destination on the Selection List, a list of hotels is compiled that (a) meets the budget and other travel requirements of the Primary Organizer and each Essential Available Co-Planner in accordance with the “HOW” parameter 108 and element 118 of FIG. 1 respectively, and (b) has availability during the Travel Dates for the Primary Organizer, each Available Co-Planner, and their intended travel companions as set forth in step 252.

In step 254, for each such hotel, a rating is determined using publicly available travel and consumer websites.

In step 256 of FIG. 5, where the Primary Organizer and the Essential Available Co-Planners have set a ratings minimum for accommodations according to the “HOW” trip parameters 108, 118 of FIG. 1 respectively, the hotels below such minimum are removed. Any hotel that significantly impairs participation in a required activity as set forth in the “WHAT” parameters 110, 116 of FIG. 1 respectively by the Primary Organizer and Essential Available Co-Planners will also be removed.

Returning to FIG. 5, in step 258, a number of hotels, not to exceed a threshold (e.g. nine (9), for example) are selected based on which hotels have the best ratings.

In step 260, if there is only one Itinerary per destination, the Decision Platform prompts the Primary Organizer to determine whether to seek the lowest price option or best quality option. If the best quality option is chosen, the hotel with the highest rating on the list is selected for the Itinerary for that particular destination.

In step 262, if the Primary Organizer elects the lowest price option, the hotel with the lowest price is identified.

In step 264, if an additional Itinerary is required for a destination under step 202 of FIG. 4, the highest rated hotel not already selected is chosen in step 266 for such additional Itinerary.

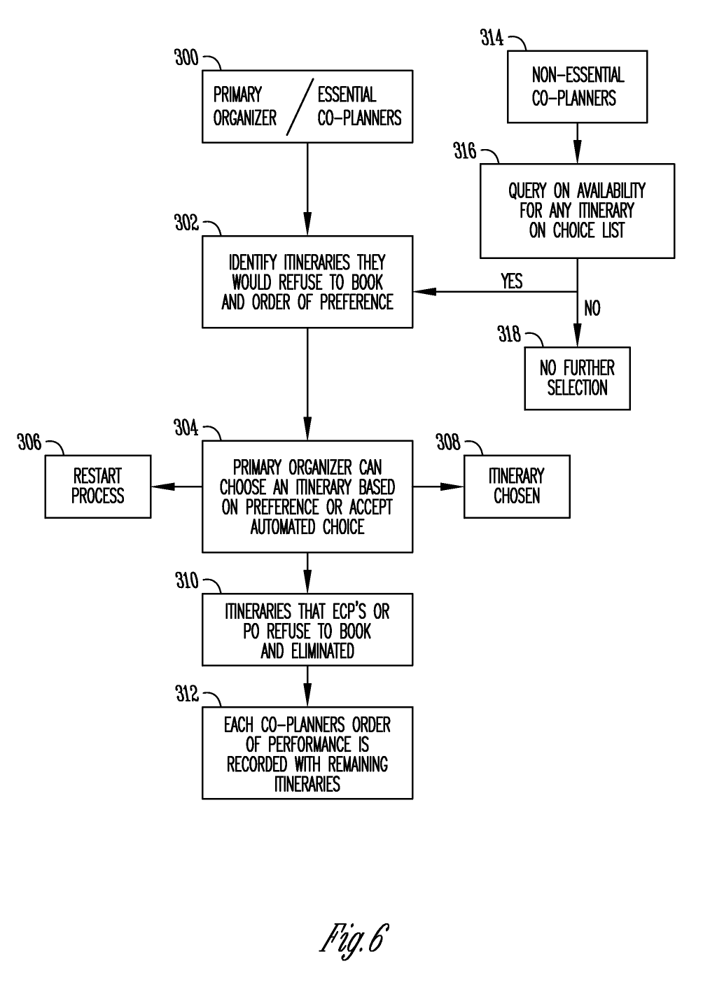

Once the required number of Itineraries (which include destinations, hotels, and the applicable Travel Date) are chosen in accordance with step 128 of FIG. 1 and further illustrated in FIGS. 2, 3, 4 and 5, they are submitted as the Choice List to the Co-Planners in step 130 of FIG. 1, as further illustrated in FIG. 6.

In step 316 of FIG. 6, each Co-Planner who is not Essential (non-essential co-planners 314) is prompted to indicate whether they would be available to travel for any of the Itineraries on the Choice List, if they say no, they will not be prompted for further selection.

In step 302 of FIG. 6, each remaining Co-Planner as well as the Primary Organizer is asked which Itineraries, if any, they would not agree to book for travel, as well as their order of preference for those Itineraries they would agree to book for travel.

In step 304 of FIG. 6, the Primary Organizer is submitted a list of each Essential Co-Planner who declines each Itinerary as well as which Itinerary is most preferred. The Primary Organizer may use this information to select an Itinerary in step 308, restart the process with new Trip Parameters in step 306, or continue to use the Decision Platform to select an Itinerary in accordance in step 310.

In step 310, each Itinerary for which the Primary Organizer or an Essential Available Co-Planner refuses to book for travel is removed from the Choice List.

In Step 312, each Itinerary remaining on the Choice List is reordered for each Available Co-Planner based on each such Available Co-Planner's order of preference submitted, subject to the removal of Itineraries in accordance with step 216 of FIG. 4. The Itinerary with the most first choices is selected.

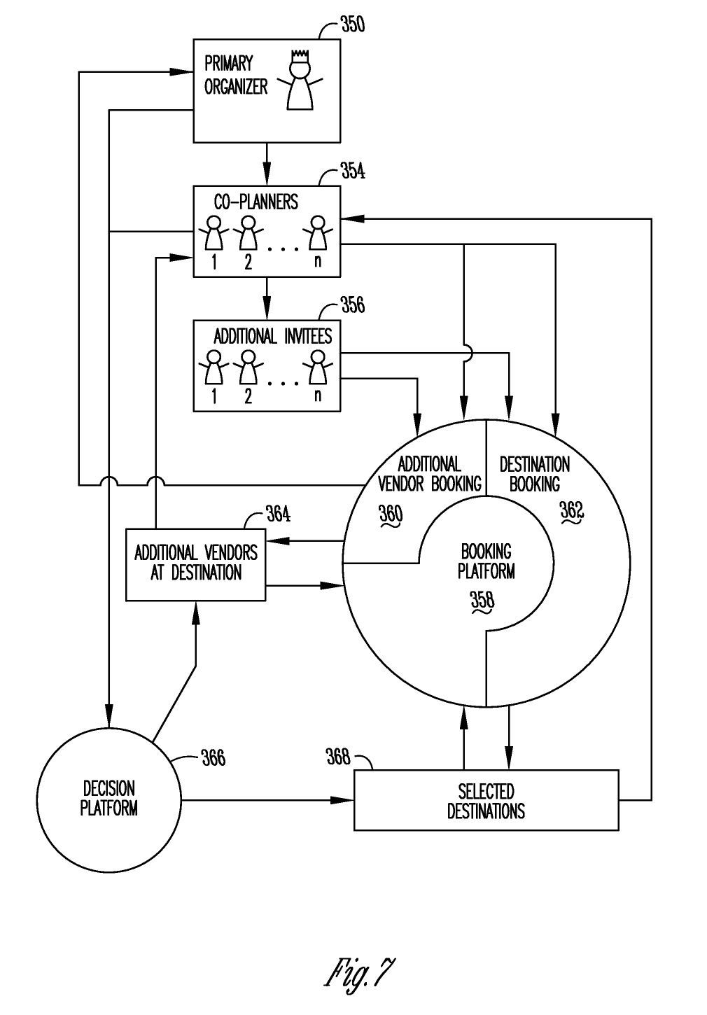

Once an Itinerary is selected, a system for booking group travel, based on the selection of an Itinerary by the Decision Platform (the “Booking Engine”) submits the Itinerary to the Primary Organizer and each Co-Planner for booking The Booking Engine is further illustrated in FIG. 7.

The Primary Organizer 350 and each Co-Planner 354 who chooses to book the Itinerary and has been given the privilege of inviting additional travelers 356 (the “WHO” 112 of FIG. 1), is then asked by the Booking Engine or Platform 358 to choose people to invite via e-mail addresses and social networks, or otherwise.

The Booking Engine 358 may also seek additional discounts from the Itinerary based on a volume of guests higher than the Primary Organizer and Co-Planners who choose to attend (each, an “Original Attendee”), and may offer such discounts to Original Attendees as an incentive to invite additional travelers, as further illustrated in FIG. 7.

The Booking Engine may also create a web-based page for the Primary Organizer and Co-Planners to continue to plan and communicate regarding the trip. Offers may be made from vendors 364 at the destinations on the Itinerary who provide activities, transportation to activities, or other entertainment experiences (such as dining, bars, or shows), tailored to the preferences submitted to the Decision Platform 366 by each Original Attendee, as further illustrated in FIG. 7. The booking platform 358 may include an additional vendor booking component for booking additional vendors. The booking platform 358 may also provide for additional selected destinations 368.

The methods and systems described herein may be implemented in various ways. For example, one or more web servers may be used to provide the user interfaces described herein to web-enabled devices including web-enabled mobile devices. In addition, the user interfaces may be provided in whole or in part by local software applications such as mobile apps which execute on a computing device but communicate over a network with one or more servers. Each server may be physical, virtual, or distributed across multiple machines. Software includes instructions for performing various steps. Software may be stored on non-transitory machine readable or non-transitory computer readable storage media.

Therefore, methods and systems for generating a group travel itinerary have been disclosed. The present invention contemplates numerous options, variations, and alternatives, including variations in the manner in which the platforms and engines are implemented, variations in the manner in which information is conveyed or presented to different users, the manner in which a group travel itinerary is build, the software and hardware used in implementing the invention, and numerous other options, variations, and alternatives.

What is claimed is:

1. A method for generating a group travel itinerary for a group, the method comprising:
providing a web site associated with a web server, the web site presenting a user interface;
identifying through the user interface a primary organizer for building a group travel itinerary using the web site;
identifying through the user interface one or more co-planners for building the group travel itinerary through the web site;
collecting trip parameters from the primary organizer through the web site;
collecting preferences from the one or more co-planners through email, the web site or other electronic interfaces;
building a plurality of group travel itineraries based on the trip parameters and the preferences, the building performed using a decision engine associated with the web site and executing on a computing device;
presenting the plurality of group travel itineraries to the primary organizer and the one or more co-planners through the web site;
receiving feedback from the primary organizer and the one or more co-planners on the plurality of group travel itineraries through the web site; and
determining a group travel itinerary based on the feedback using the decision engine.

2. The method of claim 1 further comprising booking the group travel itinerary for the primary organizer and the one or more co-planners using a booking engine.

3. The method of claim 1 further comprising inviting one or more invitees to join the group.

4. The method of claim 1 wherein one or more of the co-planners is essential.

5. The method of claim 1 wherein one or more of the co-planners is non-essential.

6. The method of claim 1 wherein the trip parameters from the primary organizer through the web site comprise when, where, how, and what.

7. The method of claim 1 wherein the preferences from the one or more co-planners comprise what, how, where, and when.

8. The method of claim 1 wherein the plurality of group travel itineraries is limited to a pre-determined maximum number of choices.

9. The method of claim 1 further comprising presenting offers to the primary organizer or one or more of the co-planners from vendors based on the group itinerary.

10. A method for generating a group travel itinerary for a group, the method comprising:
providing a web site associated with a web server, the web site presenting a user interface;
identifying through the user interface a primary organizer for building a group travel itinerary using the web site;
identifying through the user interface one or more co-planners for building the group travel itinerary through the web site;
collecting trip parameters from the primary organizer through the web site;
collecting preferences from the one or more co-planners through email, the web site or other electronic interfaces;
building a plurality of group travel itineraries based on the trip parameters and the preferences, the building performed using a decision engine associated with the web site and executing on a computing device;
presenting the plurality of group travel itineraries to the primary organizer and the one or more co-planners through the web site;
receiving feedback from the primary organizer and the one or more co-planners on the plurality of group travel itineraries through the web site; and
determining a group travel itinerary using the feedback using the decision engine;
inviting one or more invitees to join the group.

11. The method of claim 10 further comprising booking the group travel itinerary for the primary organizer and the one or more co-planners using a booking engine.

12. The method of claim 11 further comprising booking the group travel itinerary for one or more of the invitees using the booking engine.

13. The method of claim 12 further comprising presenting an offer to at least one of the primary organizer, the co-planners, or the invitees from a vendor based on the group itinerary.

14. A system for generating a group travel itinerary, the system comprising:
a user interface associated with a computing system, the user interface configured for (a) identifying a primary organizer for building a group travel itinerary, (b) identifying one or more co-planners for building the group travel itinerary, (c) collecting trip parameters from the primary organizer, (d) collecting preferences from the one or more co-planners;
a decision engine in operative communication with the computing system, the decision engine configured to build group travel itineraries based on the trip parameters and the preferences; and
a booking engine in operative communication with the computing system, the booking engine configured to book a selected one of the group travel itineraries.

15. The system of claim 14 wherein the user interface is further configured to invite one or more invitees to join the group.

16. The system of claim 15 wherein the booking engine is configured to book the selected one of the group travel itineraries for the one or more invitees.

17. The system of claim 14 wherein the trip parameters from the primary organizer comprise when, where, how, and what.

18. The system of claim 14 wherein the preferences from the one or more co-planners comprise what, how, where, and when.

19. The system of claim 14 wherein the group travel itineraries are limited in number to a pre-determined maximum number of choices.
